(19) United States
(12) Patent Application Publication
(10) Pub. No.: US 2003/0089383 A1
(43) Pub. Date: May 15, 2003

(54) Egronomic sprayer mop and method

(76) Inventor: Blyth S. Biggs, Gardnerville, NV (US)

Correspondence Address: Herbert C. Schulze, 2790 Wrondel Way, PMB 36, Reno, NV, 89502, US

(21) Appl. No.: 10/002,640

(22) Filed: Nov. 13, 2001

(51) Int. Cl. B08B 1/00

(52) U.S. Cl. 134/6

(57) ABSTRACT

This invention is a method and apparatus for enhanced cleaning of surfaces wherein a mop handle is equipped with fluid container and dispensing means including a jet nozzle and means to generate and direct steam and other fluids to a surface being mopped in conjunction with the actual mopping resulting in improved cleaning and finishing of floors and other surfaces.

### CROSS REFERENCE TO RELATED PATENT APPLICATIONS

This application is not related to any other presently pending application of mine.

### BACKGROUND OF THE INVENTION

I. Field of the Invention

This invention is in the general field of mops and mopping;

The invention is more particularly in the fields of mops equipped to spray cleaning and finishing fluids onto floors as they are bing mopped in such manner as to reduce strain and repetitive motion injuries caused by mopping and application of fluids to floors and the like.

II. Description of the Prior Art

There have been many mops of various types developed over the years, some of which have been specifically designed to attempt to reduce stress and strain. The leading mop in the field of stress and strain reducing mopping is the Biggs Ergonomic Mop which is described U.S. Pat. No. 5,920,944 of which I am a co-inventor. One phase of mopping, however, is not completely addressed by the Biggs Ergonomic Mop. This is the occasional requirement to apply a cleaning fluid or a finish to all, or specific, portions of an area being mopped.

I have studied this field at length including prior art devices and methods, literature, and patents. Also, I am personally involved in the development of methods and devices in the janitorial field and I have personally used virtually every type of mop. An example of a complex item apparently aimed at this general field is found in U.S. Pat. No. 6,101,671. However, items such as that do not solve the problem facing a janitor who may be mopping all day and cannot manage the stress and strain involved with such devices.

I have concluded that there is no prior art suggesting nor anticipating my present invention.

### SUMMARY OF THE INVENTION

Janitorial service, and the sub-category of mopping is one of the world's most common, and most necessary activities. It is engaged in, and absolutely necessary, by all cultures in the world. In all public and private human activities cleanliness and attractiveness of floors and other surfaces is of prime importance.

I have studied and innovated in the field of janitorial services for many years.

My brother and I have previously developed a unique mop handle upon which we have U.S. Pat. No. 5,920,944 which I refer to as “the ergonomic mop handle”. Therefore, I began to consider whether our mop handle could be used with a device to apply solvents and/or finishing materials to floors and the like in conjunction with normal mopping activities.

At first, I believed I could not combine a liquid dispensing apparatus with a mop being used for long periods of time since everything I had seen indicated it would be too tiring and stressful for a full time janitor. In this regard I was somewhat influenced by my knowledge of the type device represented by U.S. Pat. No. 6,101,671, mentioned above which, while no doubt a valuable device, cannot accomplish the results I had in mind.

I then returned to consideration of my brother's and my ergonomic mop handle and some way to incorporate the dispensing of solvents and finishing materials with the advantages of our mop handle. After considerable study, design, and experimentation I was able to provide a light weight, easily maneuverable, inexpensive, unique, novel and useful mop handle incorporating liquid dispensing and other features while being useable full time without undue strain or stress on the person using it.

I have accomplished this by providing a rechargeable source of electrical energy within an ergonomic mop handle and a means to carry and dispense fluids including cleaning and floor finishing fluids and even steam for difficult spots such as chewing gum and the like on floors without interfering with normal mopping.

It is an object of this invention to provide a novel, useful, and unique mop handle which will incorporate fluid dispensing means;

Another object of this invention is to provide such a mop handle with quick change mop capability;

Another object of this invention is to provide such a mop handle which can be adjusted so as to provide an improved device for mopping;

Another object if this invention is to provide such a mop handle which can dispense steam onto floors being cleaned;

Another object is to provide such a mop handle from which different fluids can be simultaneously or independently dispensed.

The foregoing and other objects and advantages of this invention will become apparent to those skilled in the art upon reading the description of a preferred embodiment, which follows, in conjunction with a review of the appended drawings.

### BRIEF DESCRIPTION OF THE DRAWINGS

FIG. 1 is a schematic perspective of a person using a preferred embodiment of a mop handle and mop which are capable of practicing the method of this invention; and

FIG. 2 is a schematic exploded view of the device shown on FIG. 1.

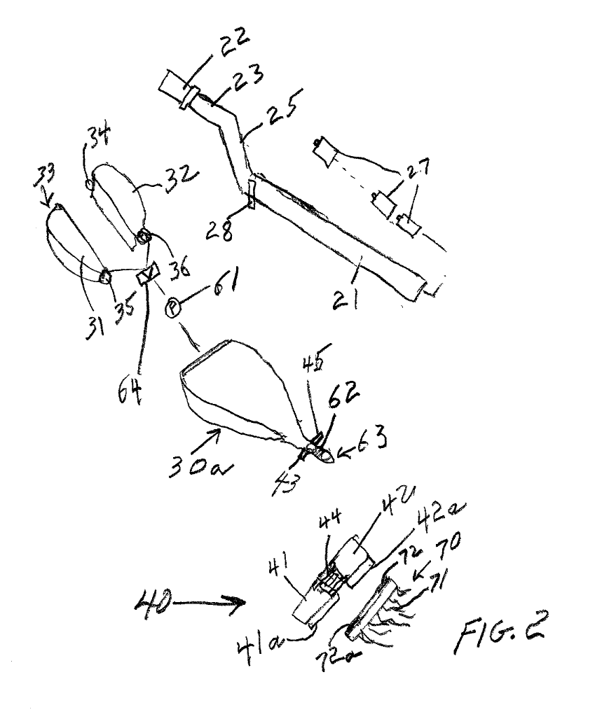

### DESCRIPTION OF A PREFERRED EMBODIMENT

An inventory of items on the drawings bearing reference numerals is:

| Numeral | Item |
|---|---|
| 10 | janitor |
| 11 | right hand |
| 12 | left hand |
| 13 | left thumb |
| 20 | ergonomic mop handle |
| 21 | straight handle portion |
| 22 | swivel grip |
| 23 | straight handle portion |
| 24 | curve |
| 25 | straight handle portion |
| 26 | curve |
| 27 | batteries |
| 28 | switch |
| 30 | fluid, pump, and sprayer assembly |
| 30a | fluid container carrier |
| 31 | fluid container |
| 32 | fluid container |
| 33 | fill spout |
| 34 | fill spout |
| 35 | fluid outlet |
| 36 | fluid outlet |
| 40 | mop head assembly |
| 41 | mop head |
| 41a | one part of hook and loop fastener material assembly |
| 42 | mop head |
| 42a | one part of hook and loop fastener material assembly |
| 43 | shaft |
| 44 | yoke assembly |
| 45 | shaft |
| 50 | dispensed fluid |
| 60 | jet nozzle assembly |
| 61 | pump |
| 62 | heated nozzle |
| 63 | jet opening |
| 64 | valve |
| 70 | mop assembly |
| 71 | string mop |
| 71 | mop strings |
| 72 | one part of hook and loop fastener material assembly |
| 72a | one part of hook and loop fastener material assembly |
| 80 | floor surface |
| 81 | chewing gum |

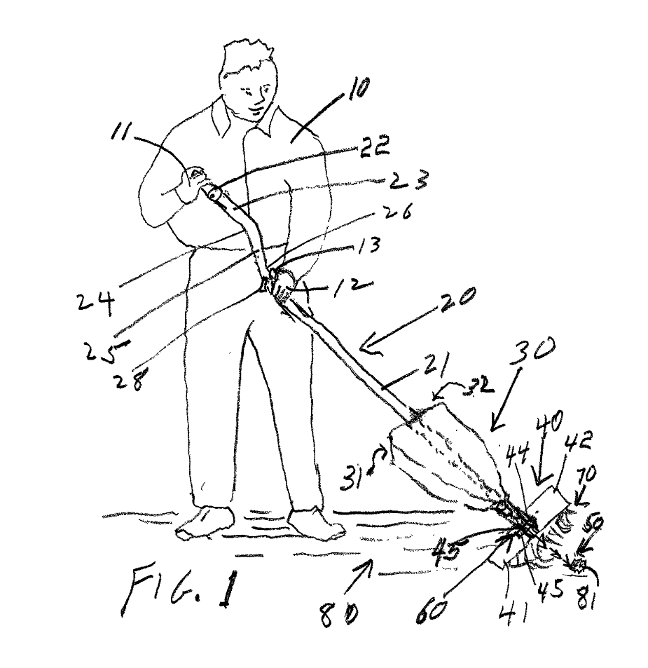

FIG. 1 shows a janitor or the like 10 using a mop assembly 70; an ergonomic mop handle 20; a fluid, pump, and sprayer jet assembly 30 including a fluid container carrier 30a, fluid containers 31 and 32, pump 61, and jet nozzle assembly 60 suitable to practice the methods, and incorporating the features, of this invention.

The janitor or the like is holding a swivel grip 22 in his right hand 11. The janitor is holding the straight handle portion 23 just below curve 26 with his left hand 12 and has his left thumb 13 ready to actuate the switch 28. The remaining straight handle portion 25 and curve 24 complete the ergonomic handle. Due to the unique, novel, and useful mop head utilized there is little stress and strain on the janitor since the weight of the fluids and the like is carried by the mop heads which glide on the surface during use.

The straight handle portion 21 is molded into, or fastened onto the fluid container carrier 31. The fluid container carrier can be made to accommodate any reasonable number of different fluids. I have illustrated two fluid containers 31 and 32 having respectively fill spouts 33 and 34 and fluid outlets 35 and 36.

I have provided a unique, novel, and useful new mop head for this new mopping tool. Mop head assembly 40 includes two mop heads 41 and 42 carrying respectively one part of hook and loop fastener material assembly 41a and 42a. These hook and loop portions accommodate the mating one part of hook and loop fastener material assembly items respectively 72a and 72 which are fastened to the strings 71 of string mop 70. In use, the mops can be very rapidly changed by using this system.

Yoke assembly 44 fastens the two mop heads together and is mounted on shafts 43 and 45. Jet nozzle assembly includes a variable three way valve operated by the janitor through switch 28 as will be understood by those skilled in the art. Thus, the janitor may have the valve closed with no fluid available to the jet nozzle or may have fluid available from one or more fluid containers. When it is desired to use fluid(s) the appropriate valve(s) is/are opened. Next, the jet nozzle opening 63 may be opened to any desired degree and the heated nozzle 62 can be activated to merely heat a fluid for improved performance or may be heated sufficiently to create steam for difficult items such a wad of chewing gum 81 on surface 80. The dispensed fluid 50 (whether steam or other fluid) aids materially in cleaning difficult areas or items or for surface treatment such as waxes or the like.

I have provided electrical power for the valves, heating coil, jet control and the like by a series of rechargeable batteries 27 carried within the hollow ergonomic handle 20.

In the claims which follow if I should fail to claim a patentable feature of this invention such failure to claim will be due to inadvertence or mistake and is not to be interpreted as an abandonment nor dedication of such feature. In the event of any such failure to claim, upon my becoming aware of the failure to claim I shall take such steps as may be appropriate to claim such invention.

While the embodiments of this invention shown and described are filly capable of achieving the objects and advantages desired, it is to be understood that such embodiments have been shown and described for purposes of illustration only and not for purposes of limitation.

I claim:

1. A mop handle comprising an elongate shaft having a first end and a second end with means to be held by a human's hands adjacent the first end, means to dispense fluid cooperatively with a mop adjacent the second end, and means to control the dispensing of the fluid adjacent the first end.

2. The apparatus of claim 1 wherein the means to dispense fluid is electrically activated by a source of electricity carried within said elongate shaft.

3. A method for cleaning surfaces comprising: equipping a shaft with means to be manipulated by human hands; equipping said shaft with fluid carrying means; equipping said fluid carrying means with jet nozzle means; equipping said shaft with jet nozzle control means; equipping said shaft with mop means; activating said jet nozzle control means in such manner as to direct a stream of fluid against said mop means and a surface; and manipulating said shaft so as to move said mop means in contact with said surface while the jet means is activated.
